(19) United States
(12) Patent Application Publication
(10) Pub. No.: US 2024/0228910 A1
(43) Pub. Date: Jul. 11, 2024

(54) COMPOSITIONS AND METHODS FOR SURFACE DISINFECTION

(71) Applicant: Berkshire Corporation, Greensboro, NC (US)

(72) Inventors: Todd Showalter, Danville, VA (US); Wenyu Zhang, Oak Ridge, NC (US)

(21) Appl. No.: 18/404,109

(22) Filed: Jan. 4, 2024

Related U.S. Application Data
(60) Provisional application No. 63/478,541, filed on Jan. 5, 2023.

(51) Int. Cl. C11D 3/20; C11D 1/37; C11D 3/40; C11D 3/48; C11D 3/50; C11D 17/00; C11D 17/04

(52) U.S. Cl. CPC C11D 3/2079; C11D 1/37; C11D 3/40; C11D 3/48; C11D 3/50; C11D 17/0008; C11D 17/041

(57) ABSTRACT

Methods and antimicrobial compositions are provided for surface cleaning. The antimicrobial compositions which include very low concentrations of an organic acid and one or more anionic surfactants can, unexpectedly, provide effective and broad spectrum antimicrobial activity within two minutes of contact with a surface and in some instances within one minute of contact time. Contacting the antimicrobial compositions with a surface can result in greater than or equal to about 4.0 log kill or 5.0 log kill for one or more of Staphylococcus aureus, Pseudomonas aeruginosa, and Salmonella enterica on the surface in two minutes or less. The compositions can have antimicrobial activity against at least one gram-positive bacterium, gram-negative bacterium, virus, and fungus in two minutes or less of contacting the composition with a surface.

### CROSS-REFERENCE TO RELATED APPLICATIONS

This application claims priority to U.S. Provisional Patent Application No. 63/478,541 filed on Jan. 5, 2023, which is incorporated by reference herein in its entirety.

### FIELD OF INVENTION

The present invention relates to antimicrobial compositions for surface cleaning, wherein the antimicrobial compositions have low concentrations of active agent and low amounts of total residue for improved health and safety.

### BACKGROUND

Broad spectrum disinfectants are necessary for use in critical and controlled manufacturing and production environments. Lactic acid is considered a safe, biobased and biodegradable option for antimicrobial products and formulations, with proven broad range efficacy against bacteria and viruses (https://www.corbion.com/-/media/Corbion/Files/PLA -PDFs-14-of-24/corbion_a_safe_antimicrobial_for_hpc_applications_eng_434618.pdf). However, current formulations that include lactic acid and that are capable of disinfecting a broad range of microorganisms including gram-positive bacteria, gram-negative bacteria, viruses, and fungi at commercially relevant contact times of two minutes or less suffer from both high levels of active ingredients and total ingredient residue. Given the high level of ingredient residue, these disinfectants present environmental and human health and safety concerns. One way to avoid high levels of total ingredient residue is to include more than one active antimicrobial ingredient in a disinfectant. However, this approach has its own health and safety concerns resulting from the combination of multiple antimicrobial active agents.

The environmental and human health and safety concerns resulting from use of disinfectants with high total residue are described in https://www.americanpharmaceuticalreview.com/Featured-Articles/594393-Cleaning -Disinfection-and-the-Problems-Caused-by-Chemical-Residues/. One concern is that surfaces that are sticky or slippery pose a safety risk. In addition, the presence of a residue ensures that the odor of the chemical lingers for a prolonged period, which can cause operator discomfort or contribute to occupational exposure levels, especially in the case of oxidizing agents used as sporicidal disinfectants. Residues can lead to discoloration, over time, of surfaces, for example, with phenolics staining vinyl. The continuing action of some types of disinfectants can cause surface damage through continued reactivity, such as chlorine ions interacting and corroding with stainless steel. The altered physiochemical properties of the surface due to the presence of the residue can aid bacterial attachment. Microorganisms attached to a surface (i.e., in a sessile state) are far more difficult to remove and inactivate compared with those that are not attached to surfaces (i.e., in a planktonic state). The residue may aid biofilm development and subsequent protection of the microbial community from disinfection. For certain applications, a disinfectant residue may present as an adulterant in terms of cross-contamination of the subsequently processed product. While this veers more into cleaning validation territory, the assessment of Maximum Residue Limits provides a related concern. Residues could lead to contamination of the disinfectant, depending on the application technique, as with some bucket systems. The development of resistant profiles can be promoted by disinfectant residues that persist in the environment at subinhibitory concentrations. The presence of a residue from one disinfectant can interfere and partly inactivate another disinfectant when it is applied to the surface. This is a potential challenge when changing disinfectants as required by a disinfectant rotation regime.

Thus, there is a need for improved antimicrobial compositions that remain effective at contact times of two minutes or less but are safer and less damaging to the environment. The present invention provides such improved antimicrobial compositions.

### SUMMARY

In one embodiment, ready to use (RTU) liquid antimicrobial compositions are provided for cleaning a surface that include an organic acid and one or more anionic surfactants, wherein the total percent by weight of the organic acid, the one or more anionic surfactants, and any additional components in the composition ranges from about 0.1% to about 0.75%. Another way of stating that the compositions are ready to use (RTU) is to say that the compositions have a composition for end use at the stated concentrations of the listed components. While the amounts of the components in the RTU compositions or the compositions for end use are specified herein, it is intended that the liquid compositions of the present disclosure include concentrated versions of the liquid compositions that can be diluted to the RTU or end use concentrations.

In another instance, a RTU liquid antimicrobial composition is provided for cleaning of a surface that includes: from about 0.01% to about 0.2% by weight of lactic acid (LA); from about 0.01% to about 0.25% by weight of linear alkylbenzenesulfonic acid (LAS); and from about 0.01% to about 0.3% by weight of sodium lauryl sulfate (SLS), wherein the total percent by weight of LA, LAS, and SLS in the composition is at least about 0.1%.

Other embodiments include a RTU liquid antimicrobial composition for cleaning of a surface that includes lactic acid (LA), linear alkylbenzenesulfonic acid (LAS), and sodium lauryl sulfate (SLS), wherein the total percent by weight of LA, LAS, and SLS, and any additional components in the composition ranges from about 0.1% to about 0.75%.

In some embodiments, liquid compositions are provided for cleaning surfaces that have a composition for end use comprising, consisting essentially of, or consisting of: from about 0.038% to about 0.15% by weight of lactic acid (LA); at least about 0.04% by weight of linear alkylbenzenesulfonic acid (LAS); and at least about 0.05% by weight of sodium lauryl sulfate (SLS), wherein the total percent by weight of LA, LAS, SLS, and any additional components in the composition is less than or equal to about 0.55%. In other words, the total residue of the compositions is less than or equal to about 0.55%.

In one embodiment, the liquid compositions for cleaning of a surface have a composition for end use comprising, consisting essentially of, or consisting of: from about 0.038% to about 0.15% by weight of lactic acid (LA); from about 0.04% to about 0.2% by weight of linear alkylbenzenesulfonic acid (LAS); and from about 0.05% to about 0.2% by weight of sodium lauryl sulfate (SLS), wherein the total percent by weight of LA, LAS, SLS, and any additional components in the composition is less than or equal to about 0.55%.

In the liquid compositions, the total percent by weight of LA, LAS, SLS, and any additional components in the composition can be less than or equal to about 0.47% or less than or equal to about 0.31%.

In another aspect, solid matrices are provided for cleaning a surface, wherein the solid matrices are impregnated with a liquid antimicrobial composition of the present disclosure.

In addition to the liquid antimicrobial compositions, methods are provided for cleaning a surface using the antimicrobial compositions. Specifically, in one embodiment, a method is provided for cleaning of a surface, the method including contacting a liquid antimicrobial composition provided herein with a surface, wherein the cleaning of the surface is affected by the contacting.

In another embodiment, a method is provided for cleaning of a surface, comprising: contacting a liquid composition or a solid matrix impregnated with the liquid composition with a surface, wherein the liquid composition has a composition for end use comprising, consisting essentially of, or consisting of: from about 0.038% to about 0.15% by weight of lactic acid (LA); at least about 0.04% by weight of linear alkylbenzenesulfonic acid (LAS); and at least about 0.05% by weight of sodium lauryl sulfate (SLS), wherein the total percent by weight of LA, LAS, SLS, and any additional components in the composition is less than or equal to about 0.55%, and wherein the cleaning of the surface is affected by the contacting.

In other embodiments, methods are provided for cleaning of a surface, comprising: contacting a liquid composition or a solid matrix impregnated with the liquid composition with a surface, wherein the liquid composition has a composition for end use comprising, consisting essentially of, or consisting of: from about 0.038% to about 0.15% by weight of lactic acid (LA); from about 0.04% to about 0.2% by weight of linear alkylbenzenesulfonic acid (LAS); and from about 0.05% to about 0.2% by weight of sodium lauryl sulfate (SLS), wherein the total percent by weight of LA, LAS, SLS, and any additional components in the composition is less than or equal to about 0.55%, and wherein the cleaning of the surface is affected by the contacting.

In the methods for cleaning a surface provided herein, the contacting of the liquid composition with the surface can be for about 2 minutes or less. In some cases, the contacting is for about 1 minute or less.

In the methods provided herein, cleaning of the surface can result in greater than or equal to about 4.0 log kill or 5.0 log kill for one or more of Staphylococcus aureus, Pseudomonas aeruginosa, and Salmonella enterica.

In another instance, the method for cleaning of the surface can result in greater than or equal to about 4.0 log kill or 5.0 log kill for each of a gram-negative and a gram-positive bacterium.

In other embodiments, cleaning of the surface according to the method provided herein can result in antimicrobial activity that includes antimicrobial activity against at least one gram-positive bacterium, at least one gram-negative bacterium, at least one virus, and at least one fungus.

### DETAILED DESCRIPTION

To promote an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise indicated, technical and scientific terms used herein have the same meaning as commonly understood by those of ordinary skill in the art to which this disclosure belongs.

The present invention provides antimicrobial compositions and methods for surface cleaning. The compositions, which include very low concentrations of an organic acid and one or more anionic surfactants can, unexpectedly, provide effective and broad-spectrum antimicrobial activity within two minutes of contact with a surface. In contrast to prior art antimicrobial formulations, the antimicrobial compositions of the present invention include components with benign health, safety, toxicological, and hazard impacts resulting in a lower environmental impact. The advantages of the low residue, broad-spectrum antimicrobial compositions of the present disclosure include human health and safety, environmental stewardship, and use in critical and controlled manufacturing and production environments. More specifically, the compositions of the present invention include from about 0.038% to about 0.15% by weight of lactic acid, and lactic acid is the only listed active antimicrobial ingredient in the compositions. The phrase “listed active antimicrobial ingredient” means an ingredient that is recognized as being an active antimicrobial agent by a governmental agency that regulates environmental conditions. For example, the Environmental Protection Agency (EPA) is such a governmental agency in the United States. In addition to lactic acid, the compositions of the present disclosure include at least about 0.04% by weight of linear alkylbenzenesulfonic acid (LAS) and at least about 0.05% by weight of sodium lauryl sulfate (SLS). The total percentage by weight of the LA, LAS, SLS, and any additional components in the compositions of the present invention is no more than 0.55%. The combination of low concentrations of LA, LAS, and SLS in the compositions provided herein works synergistically to provide unexpectedly high levels of antimicrobial activity. The compositions of the present invention contrast with prior art antimicrobial formulations, which have substantially higher concentrations of active ingredient, lactic acid, and higher total ingredient residue, or which have another active ingredient in addition to lactic acid.

For example, a prior art product with EPA Registration No. 4822-539 contains 2% lactic acid and is described for use with a 1-minute contact for surface disinfection of bacteria including S. aureus. This level of lactic acid is 13-fold higher than the highest concentration of lactic acid present in the compositions provided herein.

Another product with EPA Registration No. 67619-45 includes 0.4% lactic acid and is described for use with a 2-minute contact for surface disinfection of bacteria including S. aureus. The total residue (i.e., the percentage by weight of all components) of product No. 67619-45 has been experimentally measured at 0.818% (data not shown). In contrast, the compositions of the present invention include 0.15% lactic acid or less, which is at least 3-fold less, and have a total residue of 0.55% or less. In addition, embodiments of the compositions described herein have surprisingly been shown to achieve surface disinfection more rapidly with a contact time of only 1-minute or less.

A product with EPA Registration No. 1677-259 includes two active antimicrobial agents, lactic acid (0.16%) and dodecylbenzenesulfonic acid (DDBSA; 0.061%) and is described for use with an 8-minute contact for surface disinfection of bacteria including S. aureus. The total residue of product No. 1677-259 is unknown. In contrast, compositions described herein contain only the single listed active antimicrobial agent, lactic acid, and can achieve surface disinfection with a contact time of 2-minutes or less.

Experimentation was performed in which various test compositions were prepared that contained a range of concentrations of an organic acid and one or more anionic surfactants. These compositions were tested for antibacterial, antifungal, and antiviral activity according to the methods and procedures described in Examples 1-3, respectively. Specifically, for antibacterial activity, results were derived from EPA Method MB-06-10 Germicidal Spray

Products as Disinfectants: (GSPT): Testing of Staphylococcus aureus, Pseudomonas aeruginosa, and Salmonella enterica. In this method, a result in which no growth is recorded in a set of twenty or more carriers indicates >5.0 log kill. In addition, a score of 0/20, 0/60, and 1/60 carriers are each considered passing scores. The method used to test antifungal activity is a recognized modification of Method MB-06-10. In the assay described in Example 2, a score of 0/10 in which no growth is recorded in a set of ten carriers is a passing score. For antiviral activity, a series of antiviral tests were performed on the test compositions according to the United States Environmental Protection Agency (EPA) Standard Operating Procedure (SOP) MB-39-01, Standard Practice to Assess Virucidal Activity of Chemicals Intended for Disinfection of Inanimate, Nonporous Environmental Surfaces Using Human Coronavirus. With this method, a score of ≥3 log kill is a passing score.

Results of the experimentation are included in Tables 1-3 below. The results in Table 1 are for antimicrobial activity of the test compositions against S. aureus using a one-minute contact time. Table 2 shows results for test composition activity against S. aureus using a two-minute contact time. Table 3 shows the broad-spectrum antimicrobial activity of select test compositions against bacterial, fungal, and viral organisms using a one- or two-minute contact time. All of the results shown in Table 3 are passing scores.

TABLE 1
Activity of test compositions against S. aureus using a one-minute contact time.

| | | | | Total | | Contact | |
|---|---|---|---|---|---|---|---|
| | | | | Residue | | Time | Carriers |
| Sample | LA (%) | LAS (%) | SLS (%) | (%) | Organism | (min) | Positive* |
| Product A | 2 | N/A | N/A | ≥2.0 | S. aureus | 1 | N/A |
| LAF6 | 0.4 | 0.5 | 0.6 | 1.5 | S. aureus | 1 | 0/20 |
| LAF7 | 0.2 | 0.25 | 0.3 | 0.75 | S. aureus | 1 | 0/20 |
| LAF71 | 0.2 | 0 | 0.05 | 0.21 | S. aureus | 1 | 2/20 |
| LAF59** | 0.15 | 0.07 | 0.09 | 0.31 | S. aureus | 1 | 0/20, 0/60 |
| LAF8 | 0.12 | 0.15 | 0.18 | 0.45 | S. aureus | 1 | 0/20, 0/20, |
| | | | | | | | 2/20 |
| LAF12 | 0.12 | 0.1 | 0.18 | 0.4 | S. aureus | 1 | 1/20 |
| LAF13 | 0.12 | 0.05 | 0.18 | 0.34 | S. aureus | 1 | 0/20, 1/20 |
| LAF27 | 0.12 | 0.1 | 0.09 | 0.31 | S. aureus | 1 | 0/20 |
| LAF16 | 0.12 | 0.15 | 0 | 0.27 | S. aureus | 1 | 1/20, 0/20 |
| LAF40 | 0.09 | 0.2 | 0.12 | 0.41 | S. aureus | 1 | 0/20, 0/20 |
| LAF31 | 0.07 | 0.15 | 0.18 | 0.4 | S. aureus | 1 | 0/20, 1/20, |
| | | | | | | | 0/20 |
| LAF32 | 0.07 | 0.15 | 0.09 | 0.31 | S. aureus | 1 | 0/20, 0/20, |
| | | | | | | | 0/20, 1/60 |
| LAF34 | 0.07 | 0.2 | 0.09 | 0.36 | S. aureus | 1 | 1/20, 2/20, |
| | | | | | | | 1/20, 4/20 |
| LAF11 | 0.06 | 0.15 | 0.18 | 0.39 | S. aureus | 1 | 1/20 |
| LAF30 | 0.06 | 0.1 | 0.18 | 0.34 | S. aureus | 1 | 0/20 |
| LAF28 | 0.06 | 0.15 | 0.09 | 0.3 | S. aureus | 1 | 1/20 |
| LAF29 | 0.06 | 0.1 | 0.09 | 0.25 | S. aureus | 1 | 0/20 |
| LAF26 | 0.06 | 0.05 | 0.09 | 0.2 | S. aureus | 1 | 0/20 |
| LAF19 | 0.06 | 0.1 | 0.09 | 0.25 | S. aureus | 1 | 1/20, 0/20, |
| | | | | | | | 1/20, 0/20, |
| | | | | | | | 3/20, 2/20, |
| | | | | | | | 1/20, 1/20, |
| | | | | | | | 2/20 |
| LAF33 | 0.12 | 0.15 | 0.09 | 0.36 | S. aureus | 1 | 3/20, 6/20*** |
| LAF41 | 0.105 | 0.225 | 0.135 | 0.465 | S. aureus | 1 | 5/60*** |
| LAF18 | 0.12 | 0.05 | 0 | 0.17 | S. aureus | 1 | 5/20, 7/20 |
| LAF70 | 0.07 | 0 | 0.09 | 0.16 | S. aureus | 1 | 3/20 |
| LAF42 | 0.038 | 0.08 | 0.049 | 0.167 | S. aureus | 1 | 3/20, 3/20 |
| LAF10 | 0 | 0.15 | 0.18 | 0.33 | S. aureus | 1 | 0/20, 3/20 |
| LAF17 | 0 | 0.05 | 0.18 | 0.23 | S. aureus | 1 | 20/20, 17/20 |
| LAF25 | 0 | 0.1 | 0.09 | 0.19 | S. aureus | 1 | 7/20 |
| LAF14 | 0 | 0.15 | 0 | 0.15 | S. aureus | 1 | 6/20, 13/20 |
| LAF15 | 0 | 0.05 | 0 | 0.05 | S. aureus | 1 | 20/20 |

LA = L-lactic acid;
LAS = linear alkylbenzenesulfonic acid;
and SLS = sodium lauryl sulfate.
*Results derived from EPA Method MB-06-10 Germicidal Spray Products as Disinfectants. A result in which no growth is recorded in a set of twenty or more carriers indicates >5.0 log kill. In addition, a score of 0/20, 0/60, and 1/60 are each passing scores for this EPA test.
**LAF59 uses LAS CAS# 85536-14-7. All other formulas use LAS CAS# 68584-22-5.
***Indicate that the result is a statistical outlier.

TABLE 2
Activity of test compositions against S. aureus using a
two-minute contact time.

| | | | | Total | | Contact | |
|---|---|---|---|---|---|---|---|
| | LA | LAS | SLS | Residue | | Time | Carriers |
| Sample | (%) | (%) | (%) | (%) | Organism | (min) | positive* |
| Product B | 0.4 | N/A | N/A | 0.818 | S. aureus | 2 | N/A |
| LAF45 | 0.25 | 0 | 0 | 0.25 | S. aureus | 2 | 20/20 |
| LAF74** | 0.15 | 0.04 | 0.09 | 0.28 | S. aureus | 2 | 1/60 |
| LAF34 | 0.07 | 0.2 | 0.09 | 0.36 | S. aureus | 2 | 0/20, |
| | | | | | | | 0/20, |
| | | | | | | | 0/20 |
| LAF43 | 0.056 | 0.12 | 0.072 | 0.248 | S. aureus | 2 | 0/20 |
| LAF42 | 0.038 | 0.08 | 0.049 | 0.167 | S. aureus | 2 | 0/20 |
| LAF50 | 0.028 | 0.061 | 0.036 | 0.125 | S. aureus | 2 | 1/20 |
| LAF51 | 0.019 | 0.041 | 0.024 | 0.084 | S. aureus | 2 | 15/20 |
| LAF47 | 0 | 0.12 | 0 | 0.12 | S. aureus | 2 | 1/20 |
| LAF52 | 0 | 0.08 | 0 | 0.08 | S. aureus | 2 | 4/20 |
| LAF48 | 0 | 0 | 0.25 | 0.25 | S. aureus | 2 | 17/20 |

LA = L-lactic acid;
LAS = linear alkylbenzenesulfonic acid;
and SLS = sodium lauryl sulfate.
*Results derived from EPA Method MB-06-10 Germicidal Spray Products as Disinfectants. A result in which no growth is recorded in a set of twenty or more carriers (0/20) indicates >5.0 log kill. In addition, a score of 0/20, 0/60, and 1/60 are each passing scores.
**LAF74 uses LAS CAS# 85536-14-7. All other formulas use LAS CAS# 68584-22-5.

TABLE 3
Activity of test compositions against bacterial, fungal, and viral organisms using a
one-or two-minute contact time. All of the results shown are passing scores.

| | | | | Total | | Contact | |
|---|---|---|---|---|---|---|---|
| | LA | LAS | SLS | Residue | | Time | |
| Sample | (%) | (%) | (%) | (%) | Organism | (min) | Carriers positive* |
| LAF59*** | 0.15 | 0.07 | 0.09 | 0.31 | P. aeruginosa | 1 | 0/20 |
| LAF34 | 0.07 | 0.2 | 0.09 | 0.36 | C. albicans | 1 | 0/10, 0/10 |
| LAF32 | 0.07 | 0.15 | 0.09 | 0.31 | P. aeruginosa | 1 | 0/60 |
| LAF32 | 0.07 | 0.15 | 0.09 | 0.31 | C. albicans | 1 | 0/10, 0/10 |
| LAF32 | 0.07 | 0.15 | 0.09 | 0.31 | Poliovirus type 1 | 1 | >6.25 log kill** |
| LAF32 | 0.07 | 0.15 | 0.09 | 0.31 | Canine Parvovirus | 1 | 3.75 log kill** |
| LAF44 | 0.063 | 0.135 | 0.081 | 0.279 | C. albicans | 1 | 1/10 |
| LAF42 | 0.038 | 0.081 | 0.049 | 0.1678 | P. aeruginosa | 2 | 1/60 |

LA = L-lactic acid;
LAS = linear alkylbenzenesulfonic acid;
and SLS = sodium lauryl sulfate.
*Results derived from EPA Method MB-06-10 Germicidal Spray Products as Disinfectants. A result in which no growth is recorded in a set of twenty or more carriers indicates >5.0 log kill. In addition, a score of 0/20, 0/60, and 1/60 are each passing scores.
**Results derived from EPA Method MB-39-01 Standard Practice to Assess Virucial Activity of Chemicals Intended for Disinfection of Inanimate, Nonporous Environmental Surfaces using Human Coronavirus. A score of ≥3 log kill is a passing score.
***LAF59 uses LAS CAS# 85536-14-7. All other formulas use LAS CAS# 68584-22-5.

The experimental results provided above demonstrate that compositions including very low concentrations of lactic acid (LA), linear alkylbenzenesulfonic acid (LAS), and sodium lauryl sulfate (SLS) can provide unexpected broad spectrum antimicrobial activity within two minutes of contact with a surface. Compositions having a total percent by weight of LA, LAS, and SLS of only about 0.1% can retain broad spectrum antimicrobial activity. Such antimicrobial compositions are provided herein. See, for example, the activity at a contact time of 2 minutes of LAF50 and LAF42 (>5 log kill) against S. aureus in Table 2 which have a total reside of 0.125% and 0.168%, respectively. In addition, the greater than 5 log kill of P. aeruginosa at a contact time of 2 minutes for LAF42 is shown in Table 3. In contrast, LAF45 contains 0.25% LA without any LAS or SLS present and demonstrates a lack of antimicrobial efficacy. The experimental data in Table 1 show that compositions containing LA ranging from 0.06% to 0.15%, LAS ranging from 0.05% to 0.2%, and SLS ranging from 0.09% to 0.2% and a total residue of 0.55% or less can unexpectedly result in a 5 log or greater reduction in S. aureus at only a 1-minute contact time. The experimental data in Table 2 show that compositions containing LA ranging from 0.038% to 0.15%, LAS ranging from 0.04% to 0.15%, and SLS ranging from 0.05% to 0.09% and a total residue of 0.39% or less can unexpectedly result in a 5 log or greater reduction in S. aureus at a 2-minute contact time.

In one embodiment, a liquid composition for cleaning of a surface is provided which has a composition for end use (i.e., a RTU composition) comprising, consisting essentially of, or consisting of: from about 0.038% to about 0.15% by weight of lactic acid (LA); at least about 0.04% by weight of linear alkylbenzenesulfonic acid (LAS); and at least about 0.05% by weight of sodium lauryl sulfate (SLS), wherein the total percent by weight of LA, LAS, SLS, and any additional components in the composition is less than or equal to about 0.55%.

The phrase “consisting essentially of” as it is used herein for the purposes of the specification and claims means that the composition includes each of the components, LA, LAS, and SLS, but does not contain a component that is recognized as being an active antimicrobial agent by a governmental agency that regulates environmental conditions (i.e., a “listed active antimicrobial agent”). For example, the Environmental Protection Agency (EPA) is such a governmental agency in the United States. The compositions of the invention consisting essentially of LA, LAS, and SLS may also contain one or more additional components as long as the one or more additional components are not listed active antimicrobial agents.

In another embodiment, liquid compositions are provided for cleaning of a surface which have a composition for end use comprising, consisting essentially of, or consisting of: from about 0.038% to about 0.15% by weight of lactic acid (LA); from about 0.04% to about 0.2% by weight of linear alkylbenzenesulfonic acid (LAS); and from about 0.05% to about 0.2% by weight of sodium lauryl sulfate (SLS), wherein the total percent by weight of LA, LAS, SLS, and any additional components in the composition is less than or equal to about 0.55%.

In other embodiments, ready to use (RTU) liquid antimicrobial compositions are provided for cleaning of a surface that comprise, consist essentially of, or consist of: from about 0.01% to about 0.2% by weight of lactic acid (LA); from about 0.01% to about 0.25% by weight of linear alkylbenzenesulfonic acid (LAS); and from about 0.01% to about 0.3% by weight of sodium lauryl sulfate (SLS), wherein the total percent by weight of LA, LAS, and SLS in the composition is at least about 0.1%. The liquid composition can also include from about 0.02% to about 0.09% by weight of lactic acid (LA); from about 0.04% to about 0.20% by weight of linear alkylbenzenesulfonic acid (LAS); and from about 0.02% to about 0.18% by weight of sodium lauryl sulfate (SLS). In another example, the liquid composition includes from about 0.03% to about 0.07% by weight of lactic acid (LA); from about 0.06% to about 0.15% by weight of linear alkylbenzenesulfonic acid (LAS); and from about 0.03% to about 0.09% by weight of sodium lauryl sulfate (SLS).

In other instances, a RTU liquid antimicrobial composition is provided for cleaning of a surface that includes lactic acid (LA), linear alkylbenzenesulfonic acid (LAS), and sodium lauryl sulfate (SLS), wherein the total percent by weight of LA, LAS, SLS, and any additional components in the composition ranges from about 0.1% to about 0.75%, from about 0.1% to about 0.47%, or from about 0.1% to about 0.31%.

In the liquid compositions of the present invention, the total percent by weight of LA, LAS, SLS and any additional components in the composition can be less than or equal to about 0.55%, 0.54%. 0.53%, 0.52%, 0.51%, 0.5%, 0.49%, 0.48%, 0.47%, 0.46%, 0.45%, 0.44%, 0.43%, 0.42%, 0.41%, 0.4%, 0.39%, 0.38%, 0.37%, 0.36%, 0.35%. 0.34%, 0.33%. 0.32%, or 0.31%.

The liquid compositions of the present invention can include from about 0.05% to about 0.15% by weight of LA.

In some instances, contacting the antimicrobial liquid compositions of the invention with a surface can result in greater than or equal to about 4.0 log kill or 5.0 log kill for at least one bacterium on the surface. The phrase “greater than or equal to about 4.0 log kill or 5.0 log kill” as it is used herein means greater than or equal to about 4.0, 4.1, 4.2, 4.3, 4.4, 4.5, 4.6, 4.7, 4.8, 4.9, or 5.0 log kill. The at least one bacterium can be one or more of Staphylococcus aureus, Pseudomonas aeruginosa, and Salmonella enterica. In other cases, contacting the antimicrobial compositions with a surface can result in greater than or equal to about 4.0 log kill or 5.0 log kill for each of a gram-negative and a gram-positive bacterium. The compositions of the invention can have antimicrobial activity on a surface against at least one gram-positive bacterium, at least one gram-negative bacterium, at least one virus, and at least one fungus. In some instances, the unexpected level of antimicrobial activity is a result of a synergistic effect between low concentrations of lactic acid (LA) with the anionic surfactants linear alkylbenzenesulfonic acid (LAS) and sodium lauryl sulfate (SLS). The total percentage by weight of the combination of LA, LAS, and SLS in the antimicrobial compositions can be as low as about 0.1%. The antimicrobial activity can be achieved through direct application of the compositions in liquid form with the surface as well as through contact of the surface with solid matrices impregnated with the liquid compositions.

The surface as it is referred to herein can be a nonporous surface and can also be referred to as a hard surface.

The liquid compositions of the invention can be contacted with a surface for about 2 minutes or less or about 1 minute or less.

In one embodiment, cleaning of the surface results in greater than or equal to about 4.0 log kill or 5.0 log kill for at least one bacterium at a contact time of the liquid composition with the surface of about 1 minute or less.

In one embodiment, the liquid composition of the invention comprises at least about 0.05% by weight of LA, at least about 0.05% by weight of LAS, and at least about 0.09% by weight SLS, and cleaning of the surface results in greater than or equal to about 4.0 log kill or 5.0 log kill for at least one bacterium at a contact time of the liquid composition with the surface of about 1 minute or less.

As described herein above, concentrated versions of the RTU liquid compositions of the invention are provided that can be diluted with water or another suitable diluent. By way of non-limiting example, the compositions of the invention can be diluted with tap water, reverse osmosis (RO) water. De-ionized (DI) water and/or water for injection (WFI) prior to use. By way of non-limiting example, the liquid antimicrobial compositions can be provided as 2-fold, 5-fold, or 10-fold or more concentrates for dilution to the RTU concentration prior to use.

The liquid antimicrobial compositions of the present disclosure can also be provided in sterile versions by subjecting said compositions to one or more of the following aseptic manufacturing techniques: gamma irradiation sterilization, aseptic filtration, UV irradiation and/or ethylene oxide sterilization.

The liquid antimicrobial compositions of the present disclosure can also be provided in the form of a presaturated delivery system. In one such instance, a solid matrix impregnated with a liquid composition of the invention is provided for cleaning a surface. In one embodiment, the liquid composition includes from about 0.01% to about 0.2% by weight of lactic acid (LA); from about 0.01% to about 0.25% by weight of linear alkylbenzenesulfonic acid (LAS); and from about 0.01% to about 0.3% by weight of sodium lauryl sulfate (SLS), wherein the total percent by weight of LA, LAS, and SLS in the composition is at least about 0.1%. In another example, the liquid composition impregnated within the solid matrix comprises, consists essentially of, or consists of from about 0.02% to about 0.09% by weight of lactic acid (LA); from about 0.04% to about 0.20% by weight of linear alkylbenzenesulfonic acid (LAS); and from about 0.02% to about 0.18% by weight of sodium lauryl sulfate (SLS). In other embodiments, the liquid composition impregnated within the solid matrix comprises, consists essentially of, or consists of from about 0.02% to about 0.09% by weight of lactic acid (LA); from about 0.04% to about 0.20% by weight of linear alkylbenzenesulfonic acid (LAS); and from about 0.02% to about 0.18% by weight of sodium lauryl sulfate (SLS).

In another instance, a solid matrix impregnated with a liquid composition is provided for cleaning a surface, wherein the liquid composition has a composition for end use comprising, consisting essentially of, or consisting of: from about 0.038% to about 0.15% by weight of lactic acid (LA); from about 0.04% by weight of linear alkylbenzenesulfonic acid (LAS); and from about 0.05% by weight of sodium lauryl sulfate (SLS), wherein the total percent by weight of LA, LAS, SLS, and any additional components in the composition is less than or equal to about 0.55%, 0.54%, 0.53%, 0.52%, 0.51%, 0.5%, 0.49%, 0.48%, 0.47%, 0.46%, 0.45%, 0.44%, 0.43%, 0.42%, 0.41%, 0.4%, 0.39%, 0.38%, 0.37%, 0.36%, 0.35%, 0.34%, 0.33%, 0.32%, or 0.31%.

In other embodiments, a solid matrix impregnated with a liquid composition is provided for cleaning a surface, wherein the liquid composition has a composition for end use comprising, consisting essentially of, or consisting of: from about 0.038% to about 0.15% by weight of lactic acid (LA); from about 0.04% to about 0.2% by weight of linear alkylbenzenesulfonic acid (LAS); and from about 0.05% to about 0.2% by weight of sodium lauryl sulfate (SLS), wherein the total percent by weight of LA, LAS, SLS, and any additional components in the composition is less than or equal to about 0.55%, 0.54%, 0.53%, 0.52%, 0.51%, 0.5%, 0.49%, 0.48%, 0.47%, 0.46%, 0.45%, 0.44%, 0.43%, 0.42%, 0.41%, 0.4%, 0.39%, 0.38%, 0.37%, 0.36%, 0.35%. 0.34%, 0.33%, 0.32%, or 0.31%.

In another aspect, a solid matrix impregnated with a liquid antimicrobial composition is provided for cleaning a surface. In this case the liquid composition includes lactic acid (LA), linear alkylbenzenesulfonic acid (LAS), and sodium lauryl sulfate (SLS), wherein the total percent by weight of LA, LAS, and SLS in the composition ranges from about 0.1% to about 0.75%, from about 0.1% to about 0.47%, or from about 0.1% to about 0.31%.

The liquid composition in the various embodiments of the solid matrix can comprise from about 0.05% to about 0.15% by weight of LA.

The solid matrices can be impregnated with the liquid antimicrobial composition at a saturation ratio of about 20% to about 100% adsorption capacity of the solid matrices or a saturation ratio of about 50% to about 80% adsorption capacity of the solid matrices.

The type of solid matrix within which the liquid antimicrobial composition is impregnated can include, but is not limited to, material such as woven, non-woven, knitted, or foam material, and combinations thereof. The solid matrix can be moderately compatible or compatible with the liquid antimicrobial composition as is understood by one of ordinary skill in the art as exemplified by the following references which are herein incorporated by reference in their entireties: U.S. Pat. Nos. 6,429,183, 7,127,768, 9,096,821, 10,696,466, 6,948,873, and “Efficacy of disinfectant-impregnated wipes used for surface disinfection in hospitals”: a review. Antimicrobial Resistance & Infection Control. 8, 139 (2019).

In the various embodiments of the solid matrix provided herein, the cleaning of the surface can comprise a contact time of the liquid composition impregnated within the solid matrix with the surface of about 2 minutes or less or 1 minute or less. In one embodiment, the cleaning of the surface with the solid matrix results in greater than or equal to about 4.0 log kill or 5.0 log kill for at least one bacterium at a contact time of 2 minutes or less. In another embodiment, cleaning of the surface with the solid matrix results in greater than or equal to about 4.0 log kill or 5.0 log kill for at least one bacterium at a contact time of the liquid composition impregnated within the solid matrix with the surface of about 1 minute or less, wherein the liquid composition comprises at least about 0.05% by weight of LA, at least about 0.05% by weight of LAS, and at least about 0.09% by weight SLS. In these embodiments, the at least one bacterium can comprise one or both of Staphylococcus aureus and Pseudomonas aeruginosa, each of a gram-negative and a gram-positive bacterium, or at least one gram-positive bacterium, at least one gram-negative bacterium, at least one virus, and at least one fungus.

In the liquid antimicrobial compositions and solid matrices described above, the liquid composition can include one or more of a pH adjusting agent, a wetting agent, a foaming agent, a fragrance, a dye, a viscosity control agent, a preservative, or an additional solvent. The pH range of the liquid compositions provided herein can range from zero to about pH 7.

The liquid antimicrobial compositions and solid matrices can also include one or more additional anionic surfactants. In this case, the total percent by weight of LA, LAS, SLS, the one or more additional anionic surfactants, and any other components in the composition is no more than about 0.75%, 0.55%, 0.47%, or 0.31%. The one or more anionic surfactants can include, but is not limited to, one or more of alkyl sulfonates, secondary alkane sulfonates, alkyl sulfates, alkyl ether sulfates, aryl sulfonates, aryl sulfates, alkylaryl sulfonates, alkylaryl sulfates, alkyl ether sulfonates and alkaline earth salts.

In other embodiments, liquid antimicrobial compositions are provided that include an organic acid and one or more anionic surfactants, wherein the total percent by weight of the organic acid and the one or more anionic surfactants in the composition ranges from about 0.1% to about 0.75%, from about 0.1% to about 0.47%, or from about 0.1% to about 0.31%. In these embodiments, the organic acid can be one or a combination of formic acid, acetic acid, citric acid, and lactic acid. The one or more anionic surfactants can include alkyl sulfonates, secondary alkane sulfonates, alkyl sulfates, alkyl ether sulfates, aryl sulfonates, aryl sulfates, alkylaryl sulfonates, alkylaryl sulfates, alkyl ether sulfonates, alkaline earth salts, and combinations thereof. The liquid compositions can also include one or more of a pH adjusting agent, a wetting agent, a foaming agent, a fragrance, a dye, a viscosity control agent, a preservative, and an additional solvent.

In addition to the antimicrobial compositions described herein above, methods are provided for cleaning a surface using the antimicrobial compositions of the invention described herein above. Specifically, in one embodiment, a method is provided for cleaning of a surface, the method including contacting a liquid antimicrobial composition provided herein with a surface, wherein the cleaning of the surface is affected by the contacting.

In another embodiment, a method is provided for cleaning of a surface, comprising: contacting a liquid composition or a solid matrix impregnated with the liquid composition with a surface, wherein the liquid composition has a composition for end use comprising, consisting essentially of, or consisting of: from about 0.038% to about 0.15% by weight of lactic acid (LA); at least about 0.04% by weight of linear alkylbenzenesulfonic acid (LAS); and at least about 0.05% by weight of sodium lauryl sulfate (SLS), wherein the total percent by weight of LA, LAS, SLS, and any additional components in the composition is less than or equal to about 0.55%, 0.54%, 0.53%, 0.52%, 0.51%, 0.5%, 0.49%, 0.48%, 0.47%, 0.46%. 0.45%. 0.44%. 0.43%, 0.42%, 0.41%, 0.4%, 0.39%, 0.38%, 0.37%, 0.36%, 0.35%, 0.34%, 0.33%, 0.32%, or 0.31%, and wherein the cleaning of the surface is affected by the contacting.

In other embodiments, a method is provided for cleaning of a surface, comprising: contacting a liquid composition or a solid matrix impregnated with the liquid composition with a surface, wherein the liquid composition has a composition for end use comprising, consisting essentially of, or consisting of: from about 0.038% to about 0.15% by weight of lactic acid (LA); from about 0.04% to about 0.2% by weight of linear alkylbenzenesulfonic acid (LAS); and from about 0.05% to about 0.2% by weight of sodium lauryl sulfate (SLS), wherein the total percent by weight of LA, LAS, SLS, and any additional components in the composition is less than or equal to about 0.55%, 0.54%, 0.53%, 0.52%, 0.51%, 0.5%, 0.49%, 0.48%, 0.47%, 0.46%, 0.45%, 0.44%, 0.43%, 0.42%, 0.41%, 0.4%, 0.39%, 0.38%, 0.37%, 0.36%, 0.35%, 0.34%, 0.33%, 0.32%, or 0.31%, and wherein the cleaning of the surface is affected by the contacting.

In the methods provided for cleaning of a surface, the surface can be a nonporous surface and/or a nonporous hard surface.

In the methods for cleaning a surface described herein, the contacting can be for about 2 minutes or less. In some cases, the contacting is for about 1 minute or less.

In the methods provided herein, cleaning of the surface can result in greater than or equal to about 4.0 log kill or 5.0 log kill for at least one bacterium. The at least one bacterium can be one or both of Staphylococcus aureus and Pseudomonas aeruginosa.

In another instance, the method for cleaning of the surface can result in greater than or equal to about 4.0 log kill or 5.0 log kill for each of a gram-negative and a gram-positive bacterium.

In other embodiments, cleaning of the surface according to the methods provided herein can result in broad-spectrum antimicrobial activity that includes antimicrobial activity of greater than or equal to about 4.0 log kill or 5.0 log kill against at least one gram-positive bacterium, at least one gram-negative bacterium, at least one virus, and at least one fungus.

The gram-positive bacterium can include, but is not limited to, one or a combination of Staphylococcus aureus, Micrococcus luteus, and Enterococcus faecalis. The gram-negative bacteria can include, but is not limited to, one or a combination of Pseudomonas aeruginosa, Salmonella enterica, and Escherichia coli. The fungus can include, but is not limited to, one or a combination of Candida albicans, Trichophyton interdigitale, and Aspergillus niger. The virus can be an enveloped virus or a non-enveloped virus with the general understanding in the field that a non-enveloped virus will be more difficult to kill than an enveloped virus. The enveloped virus of the present disclosure can include, but is not limited to, one or a combination of Human Coronavirus, Influenza A Virus, and Human Immunodeficiency Virus. The non-enveloped virus can include, but is not limited to, one or a combination of a Poliovirus, Feline Calicivirus, or Rotavirus.

In some embodiments, the method that includes contacting a liquid antimicrobial composition provided herein with a surface, results in the liquid antimicrobial composition passing EPA test MB-06-10 for one or more of Staphylococcus aureus, Pseudomonas aeruginosa, and Salmonella enterica.

In some instances, the method that includes contacting a liquid antimicrobial composition provided herein with a surface, results in the liquid antimicrobial composition passing modified EPA test MB-06-10 for one or more fungi.

In some instances, the method that includes contacting a liquid antimicrobial composition provided herein with a surface, results in the liquid antimicrobial composition passing EPA test MB-39-01 for one or more viruses.

In the method for cleaning the surface, the contacting of the surface with the liquid composition can be by spraying a liquid antimicrobial composition provided herein onto the surface or by wiping or mopping the surface with a solid matrix impregnated with a liquid composition provided herein.

Following long-standing patent law convention, the terms “a,” “an,” and “the” refer to “one or more” when used in this application, including the claims. Thus, for example, reference to “a surface” includes a plurality of surfaces, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed compositions and methods. Where particular values are described in the application and claims, unless otherwise stated, it should be assumed that the term “about” means within an acceptable error range for the particular value.

The term “linear alkylbenzenesulfonic acid (LAS)” includes chemical compounds having CAS# 85536-14-7 and CAS# 68584-22-5.

The present invention will be described in more detail below through examples, but these examples are not intended to limit the present disclosure.

### EXAMPLES

### Example 1

### Testing of Compositions for Antibacterial Activity

A series of antibacterial tests were performed on the compositions described herein according to the United States Environmental Protection Agency (EPA) Standard Operating Procedure (SOP) MB-06-10, Germicidal Spray Products as Disinfectants (GSPT): Testing of Staphylococcus aureus, Pseudomonas aeruginosa, and Salmonella enterica.

The experiments were performed as described below.

Defrost a single bacterial cryovial at room temperature and briefly vortex to mix. Add 10 μL of the thawed frozen stock (single use) to a tube containing 10 mL of synthetic broth. Vortex and incubate at 36±1° C. for 24±2 h. One daily transfer is required prior to the inoculation of a final test culture. Daily cultures may be sub-cultured for up to 5 days; each daily culture may be used to generate a test culture.

To generate test cultures, inoculate a sufficient number of 20×150 mm tubes containing 10 mL synthetic broth with 10 μL per tube of the 24 h culture, then vortex to mix. Incubate 48-54 h at 36+1° C.

Inoculate a sufficient number of carriers; 60 or 20 carriers are required for testing, 6 for control carrier counts, and 1 for the viability control. Using a vortex-style mixer, mix 48-54 h test cultures for 3-4 s and let stand 10 min at room temperature before continuing. Remove the upper portion of each culture (e.g., upper ¾), leaving behind any debris or clumps, and transfer to a sterile flask; pool cultures in the flask and swirl to mix. Use the test culture for carrier inoculation within 30 minutes. Add 5% (v/v) organic soil (fetal bovine serum). Swirl to mix. Transfer an aliquot (e.g., ˜10 mL) of the final test culture into a sterile tube for carrier inoculation. Vortex-mix the inoculum periodically during the inoculation of carriers. Use a calibrated positive displacement pipette to transfer 0.01 mL of the culture to the sterile test carrier in the Petri dish. Immediately spread the inoculum uniformly using a sterile loop. Do not allow the inoculum to contact the edge of the glass slide carriers. Cover dish immediately.

Dry carriers in incubator at 36±1° C. for 30-40 min. Perform efficacy testing within two hours of drying. Assay dried carriers in 2 sets of three carriers, one set immediately prior to conducting the efficacy test and one set immediately following the test. Randomly select 6 inoculated carriers for carrier count analysis prior to efficacy testing. Place each of the inoculated, dried carriers in a 38×100 mm culture tube or sterile 50 mL polypropylene conical tube containing 20 mL of letheen broth. Vortex immediately for 120 seconds. After vortexing, briefly mix and make serial ten-fold dilutions in 9 mL dilution blanks. Briefly vortex and plate 0.1 mL aliquots of appropriate dilutions in duplicate on Trypticase soy agar (TSA) or TSA with 5% sheep blood (BAP) using spread plating. Plate appropriate dilutions to achieve colony counts in the range of 30-300 colony forming units (CFU) per plate. Spread inoculum evenly over the surface of the agar. Plates must be dry prior to incubation. If the serial dilutions are not made and plated immediately, keep the tubes at 2-5° C. until this step can be done. Complete the dilutions and plating within 2 h after vortexing. Incubate plates (inverted) at 36±1° C. for up to 48±2 h. Count colonies. Plates that have colony counts over 300 will be reported as TNTC.

After the required carrier drying time, spray the slides sequentially for a specified contact time, with the nozzle of spray bottle about 7 inches from carrier, and 3 pumps at each 15-20 seconds with the carriers in a horizontal position. Use a certified timer to time the spray interval. Spray the slide within ±5 seconds of the specified time for a contact time of 1-10 minutes or within ±3 seconds for contact times <1 minute. After spraying, maintain the carriers in a horizontal position. Treated carriers must be kept undisturbed during the contact time. After the last slide of a set (typically 20 slides) has been sprayed with the disinfectant and the exposure time is complete, sequentially transfer each slide into the primary subculture tube containing the appropriate neutralizer within the ±5 second time limit. Drain the excess disinfectant from each slide prior to transfer into the neutralizer tube. Drain carriers without touching the Petri dish or filter paper. Perform transfers with flame sterilized or autoclaved forceps.

After the slide is deposited, recap the subculture tube and shake it thoroughly. Incubate at 36±1° C. for 48±2 h. If a secondary subculture tube is deemed necessary to achieve neutralization, then transfer the carrier from the primary tube to a secondary tube of sterile medium after a minimum of 30±5 min at room temperature from the end of the initial transfer. Within 25-60 min of the initial transfer, transfer the carriers using a sterile forceps to a second subculture tube. Move the carriers in order but the movements do not have to be timed. Thoroughly shake the subculture tubes after all of the carriers have been transferred. Incubate both the primary and secondary subculture tubes 48±2 h at 36±1° C.

For viability controls, place 1 (or 2) dried inoculated untreated carrier(s) into separate tubes of the neutralizing subculture broth (if primary and secondary media are different). Incubate tubes with the efficacy test. Report results as + (growth) or 0 (no growth) as determined by presence or absence of turbidity. Growth should occur in both tubes.

For sterility controls, place one sterile, uninoculated carrier into a tube of neutralizing subculture broth. Incubate tube with the efficacy test. Report results as + (growth), or 0 (no growth) as determined by presence or absence of turbidity. Growth should not occur in the tube.

Gently shake each tube prior to recording results. Record results as + (growth) or 0 (no growth) as determined by presence or absence of turbidity. Count the total number of +'s as # and record as #/20 or #/60. If secondary subculture tubes are used, the primary and secondary subculture tubes for each carrier represent a “carrier set.” A positive result in either the primary or secondary subculture tube is considered a positive result for a carrier set.

The results are considered passing according to this SOP MB-06-10 if there is no growth recorded in a set of either twenty or sixty carriers and also if there is only one carrier positive for growth out of a set of sixty carriers (i.e.,0/20, 0/60 and 1/60 are considered passing results).

Results of the testing are shown in Tables 1-3 provided herein.

### Example 2

### Testing of Compositions for Antifungal Activity

A series of antifungal tests were performed on the compositions described herein according to the modified United States Environmental Protection Agency (EPA) Standard Operating Procedure (SOP) MB-06-10, Germicidal Spray Products as Disinfectants (GSPT): Testing of Staphylococcus aureus, Pseudomonas aeruginosa, and Salmonella enterica.

The experiments were performed as described below.

Pick one colony of C. albicans (ATCC 10231) that has been previously streaked on Sabouraud Dextrose Agar (SDA) using a sterile loop and inoculate a minimum of 10 ml Sabouraud Dextrose Broth (SDB). Incubate 20-25° C. for 2-3 days. One daily transfer is required prior to the inoculation of a final test culture. Daily cultures may be sub-cultured for up to 5 days; each daily culture may be used to generate a test culture. To generate test cultures, inoculate a sufficient number of 15 or 50 mL centrifuge tubes containing 10-40 mL SDB with 10 μL per tube of the 24 h culture, then vortex to mix. Incubate 2-3 days at 20-25° C. The final test culture shall be concentrated or diluted to achieve a final microbial load of 4.0-5.0 log/carrier.

Inoculate a sufficient number of carriers; 60 or 20 carriers are required for testing, 6 for control carrier counts, and 1 for the viability control. Using a vortex-style mixer, mix 48-54 h test cultures for 3-4 s and let stand 10 min at room temperature before continuing. Remove the upper portion of each culture (e.g., upper ¾), leaving behind any debris or clumps, and transfer to a sterile flask; pool cultures in the flask and swirl to mix. Use the test culture for carrier inoculation within 30 minutes. Add 5% (v/v) organic soil (fetal bovine serum). Swirl to mix. Transfer an aliquot (e.g., ˜10 mL) of the final test culture into a sterile tube for carrier inoculation. Vortex-mix the inoculum periodically during the inoculation of carriers. Use a calibrated positive displacement pipette to transfer 0.01 mL of the culture to the sterile test carrier in the Petri dish. Immediately spread the inoculum uniformly using a sterile loop. Do not allow the inoculum to contact the edge of the glass slide carriers. Cover dish immediately.

Dry carriers in incubator at 36±1° C. for 30-40 min. Perform efficacy testing within two hours of drying. Assay dried carriers in 2 sets of three carriers, one set immediately prior to conducting the efficacy test and one set immediately following the test. Randomly select 6 inoculated carriers for carrier count analysis prior to efficacy testing. Place each of the inoculated, dried carriers in a 38×100 mm culture tube or sterile 50 mL polypropylene conical tube containing 20 mL of letheen broth. Vortex immediately for 120 seconds. After vortexing, briefly mix and make serial ten-fold dilutions in 9 mL dilution blanks. Briefly vortex and plate 0.1 mL aliquots of appropriate dilutions in duplicate on Trypticase soy agar (TSA) or TSA with 5% sheep blood (BAP) using spread plating. Plate appropriate dilutions to achieve colony counts in the range of 30-300 colony forming units (CFU) per plate. Spread inoculum evenly over the surface of the agar. Plates must be dry prior to incubation. If the serial dilutions are not made and plated immediately, keep the tubes at 2-5° C. until this step can be done. Complete the dilutions and plating within 2 h after vortexing. Incubate plates (inverted) at 36±1° C. for up to 48±2 h. Count colonies. Plates that have colony counts over 300 will be reported as TNTC.

After the required carrier drying time, spray the slides sequentially for a specified contact time, with the nozzle of spray bottle about 7 inches from carrier, and 3 pumps at each 15-20 seconds with the carriers in a horizontal position. Use a certified timer to time the spray interval. Spray the slide within ±5 seconds of the specified time for a contact time of 1-10 minutes or within ±3 seconds for contact times <1 minute. After spraying, maintain the carriers in a horizontal position. Treated carriers must be kept undisturbed during the contact time. After the last slide of a set (typically 20 slides) has been sprayed with the disinfectant and the exposure time is complete, sequentially transfer each slide into the primary subculture tube containing the appropriate neutralizer within the ±5 second time limit. Drain the excess disinfectant from each slide prior to transfer into the neutralizer tube. Drain carriers without touching the Petri dish or filter paper. Perform transfers with flame sterilized or autoclaved forceps.

After the slide is deposited, recap the subculture tube and shake it thoroughly. Incubate at 36±1° C. for 48±2 h. If a secondary subculture tube is deemed necessary to achieve neutralization, then transfer the carrier from the primary tube to a secondary tube of sterile medium after a minimum of 30±5 min at room temperature from the end of the initial transfer. Within 25-60 min of the initial transfer, transfer the carriers using a sterile forceps to a second subculture tube. Move the carriers in order but the movements do not have to be timed. Thoroughly shake the subculture tubes after all of the carriers have been transferred. Incubate both the primary and secondary subculture tubes 48±2 h at 36±1° C.

For viability controls, place 1 (or 2) dried inoculated untreated carrier(s) into separate tubes of the neutralizing subculture broth (if primary and secondary media are different). Incubate tubes with the efficacy test. Report results as + (growth) or 0 (no growth) as determined by presence or absence of turbidity. Growth should occur in both tubes.

For sterility controls, place one sterile, uninoculated carrier into a tube of neutralizing subculture broth. Incubate tube with the efficacy test. Report results as + (growth), or 0 (no growth) as determined by presence or absence of turbidity. Growth should not occur in the tube.

Gently shake each tube prior to recording results. Record results as + (growth) or 0 (no growth) as determined by presence or absence of turbidity. Count the total number of +'s as # and record as #/20 or #/60. If secondary subculture tubes are used, the primary and secondary subculture tubes for each carrier represent a “carrier set.” A positive result in either the primary or secondary subculture tube is considered a positive result for a carrier set.

The results are considered passing according to this modified SOP MB-06-10 if there is no growth recorded in a set of ten carriers.

### Example 3

### Testing of Compositions for Antiviral Activity

A series of antiviral tests were performed on the compositions described herein according to the United States Environmental Protection Agency (EPA) Standard Operating Procedure (SOP) MB-39-01, Standard Practice to Assess Virucidal Activity of Chemicals Intended for Disinfection of Inanimate, Nonporous Environmental Surfaces Using Human Coronavirus.

The experiments were performed as described below:

Thaw a cryovial rapidly in a 37° C. water bath to avoid loss in the viability of the preserved virus. Use an appropriate dilution scheme to achieve control counts in the range of (6.3×10⁴ to 2.0×10⁶) infective units/carrier. Dilute the virus stock prior to preparing the virus with the soil load. Vortex the diluted virus for 10-30 sec. To obtain 1 mL of the final test suspension with 5% soil load, add 50 μl of fetal bovine serum (FBS) to 950 μl of the diluted virus stock. Use final test suspension to inoculate carriers within 30 minutes of preparation. Vortex the final test suspension for 10 seconds following addition of soil load and immediately prior to use. Prepare virus films by adding 200 μl of final test suspension to the inside bottom of the carrier. Add in approximately 10-12 small drops in the middle of the carrier. Use a sterile cell scraper to spread the inoculum evenly without touching the sides of the carrier. Use 1 carrier for virucidal activity test per lot of disinfectant and 1 carrier for the plate recovery control plus extras. Dry the virus films with the lids ajar in the biological safety cabinet (BSC) at 22±2° C. until visibly dry (15-60 minutes). Ensure all carriers are dry before beginning the test. Use dried inoculated carriers for testing within 2 hours of drying; hold carriers at room temperature (22±2° C.) until use.

For each lot of the test substance, treat a dried carrier with 2.0 mL of the use-dilution of a liquid product or the amount of product released during recommended use of the aerosol or trigger spray. Rock the carrier gently to evenly distribute the test substance over the entire surface of the carrier. If the test substance does not cover the carrier within 20 seconds discard that carrier and repeat the assay using a new dried carrier. The contact time will begin when the carrier has been completely covered by the test substance. Cover the carrier with the top of the Petri dish. Hold the treated carrier for the required contact time. Within ±5 s of the end of the contact time add 2.0 mL neutralizer to the carrier and rock the carrier gently to mix well. Add the scraped suspension to a previously prepared gel filtration column and push the solution through the gel filtration column utilizing the syringe plunger. Prepare serial 10-fold dilutions (0.5 mL+4.5 mL Cryoprotective Medium ((CGM) with 2% FBS) within 30 minutes of neutralization. Remove the CGM from the wells of a 24 well plate with an 80-95% confluent monolayer of cells and add 1 mL per well to at least four replicate cell monolayers per dilution. Process from most dilute to least dilute. Start the plating of the dilutions within 30 minutes of them being made.
Incubate plates at 35±1° C. in 5% CO₂ for 6-9 days.

Assay 1 carrier as the carrier recovery control after the virucidal activity control (control test carrier has been processed. After drying, overlay the dried control film with 2.0 ml of neutralizer or another buffered solution harmless to the virus and its host cells. Rock the carrier gently to evenly distribute the liquid over the entire surface of the carrier. The contact time will begin when the carrier has been completely covered by the control solution. Cover the carrier with the top of the Petri dish. Hold the plate recovery control carrier for the same required contact time used for the treated carrier. Upon completion of the contact time, use the same neutralization procedure used for the treated carrier. Regardless of the neutralization procedure used, the resulting suspension is the 10⁻¹ dilution of the virus. Prepare serial 10-fold dilutions (0.5 mL+4.5 mL CGM with 2% FBS) within 30 minutes of neutralization. Inoculate 1 mL per well to at least four replicate cell monolayers/dilution in a 24 well plate starting from the first ten-fold dilution of the post neutralized sample within 30 minutes of the dilutions being made. Incubate plates at 35±1° C. in 5% CO₂ for 6-9 days.

To ensure the CGM with 2% FBS is not contaminated, remove the growth media on at least one well and replace it with the CGM with 2% FBS used in the test. Use an aliquot of the stock virus (i.e. the 10⁻¹ dilution tube of the plate recovery control) and inoculate onto the cells to confirm that the cells are susceptible to the virus. A lack of typical virus-induced cytopathic effects invalidates the test. Any obvious contamination or degeneration in such monolayers invalidates the test.

If desired, serially dilute an aliquot of the stock virus to confirm that the titer of the stock virus is appropriate for use in the test. Record results as positive or negative for the presence of CPE in each well after 6-9 total days of incubation. 1

Record all observations (presence/absence of CPE) and use in calculations to estimate the log reduction based on TCID₅₀. Record the last cytotoxic dilution. Record the first dilution that is successfully neutralized. For calculation purposes, the total volume of liquid on the carrier (test substance+neutralizer) is based on the control carrier. Use values with at least three significant figures when performing calculations (e.g., log density, mean log density). Report the final mean log reduction value with two significant figures (e.g., round up to the nearest tenth). Calculate the TCID₅₀/carrier and the log density of each carrier by taking the log₁₀ of the density (per carrier). Calculate the mean log₁₀ density of the treated plate. Calculate the mean log₁₀ density of the control plate Calculate the log₁₀ reduction (LR) for treated plate: log₁₀ reduction=the log₁₀ density for the control plate minus the mean log₁₀ density for the treated plate.

The results are considered passing according to this SOP MB-039-10 if there is ≥3.00 log₁₀ reduction past the level of cytotoxic dilution.

What is claimed is:

1. A method for cleaning of a surface, comprising: contacting a liquid composition or a solid matrix impregnated with the liquid composition with a surface, wherein the liquid composition has a composition for end use comprising:
from about 0.038% to about 0.15% by weight of lactic acid (LA);
at least about 0.04% by weight of linear alkylbenzenesulfonic acid (LAS); and
at least about 0.05% by weight of sodium lauryl sulfate (SLS),
wherein the total percentage by weight of LA, LAS, SLS, and any additional components in the composition is less than or equal to about 0.55%, and wherein the cleaning of the surface is affected by the contacting.

2. The method of claim 1, wherein the total percent by weight of LA, LAS, SLS, and any additional components in the composition is less than or equal to about 0.47% or is less than or equal to about 0.31%.

3. The method of claim 1, wherein the composition comprises from about 0.05% to about 0.15% by weight of LA.

4. The method of claim 1, wherein the contacting is for about 2 minutes or less.

5. The method of claim 4, wherein the cleaning of the surface results in greater than or equal to about 4.0 log kill for at least one bacterium.

6. The method of claim 1, wherein the contacting is for about 1 minute or less.

7. The method of claim 1, wherein the composition comprises at least about 0.05% by weight of LA, at least about 0.05% by weight of LAS, and at least about 0.09% by weight SLS, wherein the contacting is for about 1 minute or less, and wherein the cleaning of the surface results in greater than or equal to about 4.0 log kill for at least one bacterium.

8. The method of claim 7, wherein the at least one bacterium comprises one or both of Staphylococcus aureus and Pseudomonas aeruginosa.

9. The method of claim 7, wherein the at least one bacterium comprises each of a gram-negative and a gram-positive bacterium.

10. The method of claim 7, wherein the at least one bacterium comprises at least one gram-positive bacterium, at least one gram-negative bacterium, at least one virus, and at least one fungus.

11. The method of claim 1, wherein the liquid composition comprises one or more of a pH adjusting agent, a wetting agent, a foaming agent, a fragrance, a dye, a viscosity control agent, a preservative, or an additional solvent.

12. The method of claim 1, wherein the liquid composition further comprises one or more additional anionic surfactants, and wherein the total percent by weight of LA, LAS, SLS, the one or more additional anionic surfactants, and any additional components in the composition is no more than about 0.47% or 0.31%.

13. The method of claim 1, wherein the contacting of the surface with the liquid composition is by spraying the liquid composition onto the surface or by wiping or mopping the surface with the solid matrix impregnated with the liquid composition.

14. The method of claim 13, wherein the solid matrix is impregnated with the liquid composition at a saturation ratio of 20-100% adsorption capacity of the solid matrix or a saturation ratio of 50-80% adsorption capacity of the solid matrix.

15. The method of claim 13, wherein the solid matrix comprises a non-woven, knitted, woven, or foam material, and combinations thereof.

16. A liquid composition for cleaning of a surface which has a composition for end use comprising:
from about 0.038% to about 0.15% by weight of lactic acid (LA);
at least about 0.04% by weight of linear alkylbenzenesulfonic acid (LAS); and
at least about 0.05% by weight of sodium lauryl sulfate (SLS),
wherein the total percentage by weight of LA, LAS, SLS, and any additional components in the composition is less than or equal to about 0.55%.

17. The liquid composition of claim 16, wherein the total percent by weight of LA, LAS, SLS and any additional components in the composition is less than or equal to about 0.47% or less than or equal to about 0.31%.

18. The liquid composition of claim 16, wherein the composition comprises from about 0.05% to about 0.15% by weight of LA.

19. The liquid composition of claim 16, wherein the composition comprises one or more of a pH adjusting agent, a wetting agent, a foaming agent, a fragrance, a dye, a viscosity control agent, a preservative, or an additional solvent.

20. The liquid composition of claim 16, wherein the composition further comprises one or more additional anionic surfactants, and wherein the total percent by weight of LA, LAS, SLS, the one or more additional anionic surfactants, and any additional components in the composition is no more than about 0.55%, 0.47%, or 0.31%.

21. A solid matrix impregnated with a liquid composition for cleaning a surface, wherein the liquid composition has a composition for end use comprising:
from about 0.038% to about 0.15% by weight of lactic acid (LA);
from about 0.04% by weight of linear alkylbenzenesulfonic acid (LAS); and
from about 0.05% by weight of sodium lauryl sulfate (SLS),
wherein the total percentage by weight of LA, LAS, SLS, and any additional components in the composition is less than or equal to about 0.55%.

22. The solid matrix of claim 21, wherein the total percent by weight of LA, LAS, SLS, and any additional components in the composition is less than or equal to about 0.47% or less than or equal to about 0.31%.

23. The solid matrix of claim 21, wherein the composition comprises from about 0.05% to about 0.15% by weight of LA.

24. The solid matrix of claim 21, wherein the solid matrix is impregnated with the liquid composition at a saturation ratio of about 20% to about 100% adsorption capacity of the solid matrix or a saturation ratio of about 50% to about 80% adsorption capacity of the solid matrix.

25. The solid matrix of claim 21, wherein the liquid composition comprises one or more of a pH adjusting agent, a wetting agent, a foaming agent, a fragrance, a dye, a viscosity control agent, a preservative, and an additional solvent.
